(19) United States
(12) Patent Application Publication
(10) Pub. No.: US 2014/0060889 A1
(43) Pub. Date: Mar. 6, 2014

(54) Removable Protective Terminal Shield

(71) Applicants: Dean Pournaras, Carlsbad, CA (US); Louia Weidman, Carlsbad, CA (US)

(72) Inventors: Dean Pournaras, Carlsbad, CA (US); Louia Weidman, Carlsbad, CA (US)

(21) Appl. No.: 13/598,486

(22) Filed: Aug. 29, 2012

(51) Int. Cl. H01R 4/70

(52) U.S. Cl. 174/138 F

(57) ABSTRACT

A removable protective terminal shield is a snap-off or breakaway cap that is molded into the plastic enclosure of a lighting control device that covers the neutral wire input hole and, if desired, the head of the terminal screw used to tighten the terminal to the wire after it is inserted into the hole. The terminal input or connection is securely protected until it is determined that an alternative wiring option is available and then the terminal shield is easily removable.

### FIELD OF THE INVENTIONS

The inventions described below relate to the field of electrical construction components and more specifically to removable shields for protecting electrical terminals.

### BACKGROUND OF THE INVENTIONS

Lighting control devices are available that can be powered from line (hot) and neutral power connections or from line (hot) and earth ground connections, the latter are commonly referred to as leakage to ground devices. Leakage to ground devices are restricted under Underwriters Laboratories (UL) standards to a maximum of 0.5 mA of leakage current. In residential and older commercial applications it is uncommon for neutral wires to be available, but an earth ground wire is available for safety purposes.

Due to the proliferation of such leakage devices which are used particularly in large buildings, there may literally be thousands of such devices in a single building. In large buildings, the earth ground connection is made unreliable because all the leakage current may alter the voltage potential at the earth ground connection for the building. This may interfere with certain equipment that requires a zero potential earth ground. Building codes and regulations are changing such that neutral wire connections will be required in all new construction. As these codes roll out, manufacturers of lighting controls are required to have both neutral connection and leakage to ground connection products available in order to compete in the lighting controls market. However, maintaining separate models of these devices is costly and takes up valuable shelf space, e.g., at an electrical supply distributor.

UL standards forbid providing both a neutral and ground connection for power in lighting controls for safety reasons. One approach in the art (SensorSwitch WSD NGX) is to make a product convertible in the field from a ground connection to a neutral connection by putting a green (ground) cover slip over a white (neutral) wire (or flying lead as is known in the industry). The wire with the green cover slip is considered an earth connection for a leakage to ground installation. If the installer sees that a neutral connection is available, he/she removes the green cover slip (by first cutting off a wire terminal that helps hold the slip into place over the wire), thereby exposing the white wire that can then be connected to neutral. This approach requires multiple steps on the part of the installer, which can lengthen the time to complete an installation involving hundreds of devices.

Slidable or rotatable covers are well known in the art, particularly for receptacle outlets. Such covers are not approved by UL as safety coverings because they may fail and slid out of the way, thereby exposing a neutral terminal to which could be miswired a ground wire, causing a safety hazard.

### SUMMARY

The devices and methods described below provide for a snap-off or breakaway cap that is molded into the plastic enclosure of a lighting control device that covers the neutral wire input hole and, if desired, the head of the terminal screw used to tighten the terminal to the wire after it is inserted into the hole. The terminal input or connection is securely protected until it is determined that an alternative wiring option is available and then the terminal shield is easily removable.

For example, the cap may be held to the surface of an enclosure by at least one, preferably at least two, plastic linkages. Preferably, the snap-off cap has molded in features to engage a common screwdriver or similar tool, e.g., a Philips screwdriver but could be straight edge screwdriver or a hex socket for an Allen wrench or similar. The tool is engaged into the mating features in the cap and the tool is used to break off the cap. Alternatively, the snap-off cap may be designed to allow a tool, such as a flat blade screwdriver, to be inserted under the cap, and the screwdriver to apply a lever motion to pop the cap off of the enclosure. The neutral terminal connection is then exposed for wiring to a neutral power wire. The ground wire may be left connected or disconnected and simply capped off, e.g., using a wire nut as is known in the industry.

Technically, if the terminal screw is designed such that it is not possible to place a wire under the head of the screw, e.g., by recessing the terminal assembly inside of the enclosure and only exposing a portion of the head of the screw in an opening, then all that is needed is to place the snap-off cap over the hole into which the wire would be placed. If the terminal screw head is more exposed, then a snap-off cap may be provided that covers the head and prevents insertion of a wire underneath of the head.

### BRIEF DESCRIPTION OF THE DRAWINGS

FIG. 1 is a perspective view of the rear of a lighting control device with a removable protective terminal shield.

FIG. 2 is a perspective view of the rear of a lighting control device with an alternate removable protective terminal shield.

FIG. 3 is a top view of the removable protective terminal shield of FIG. 1.

FIG. 4 is a side view of the removable protective terminal shield of FIG. 1.

FIG. 5 is a bottom view of the removable protective terminal shield of FIG. 1.

FIG. 6 is a top view of the removable protective terminal shield of FIG. 2.

FIG. 7 is a side view of the removable protective terminal shield of FIG. 2.

FIG. 8 is a bottom view of the removable protective terminal shield of FIG. 2.

### DETAILED DESCRIPTION OF THE INVENTIONS

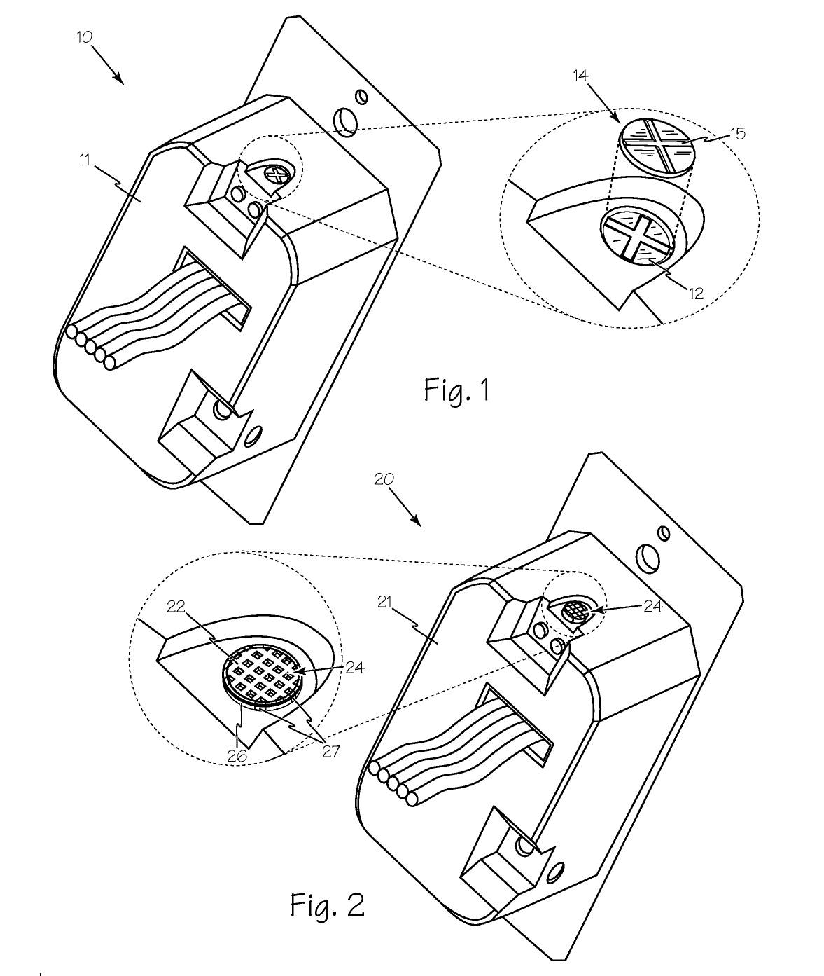

Electrical control device 10 of FIG. 1 includes housing 11 to enclose the internal elements of the control device. Some connector components of control device 10 such as neutral connector 12 must be accessible from outside housing 11. In some installation situations, neutral connector 12 must not be used. To prevent accidental connection to neutral connector 12, terminal shield 14 is removably secured to housing 11 at two or more points to protect neutral connector 12 from being contacted by any electrical conductor without removing the terminal shield. Terminal shield 14 is formed with any suitable engagement feature or features for common tools such as a straight slot for a screwdriver, perpendicular slots to engage a Phillips screwdriver, a hexagonal socket for engaging an Allen wrench, a Torx® socket or other feature. Shield body 15 of terminal shield 14 includes perpendicular slots 16 to engage a Phillips or standard screwdriver.

Electrical control device 20 of FIG. 2 includes housing 21 to enclose the internal elements of the control device. Shield body 22 of terminal shield 24 is formed with a grid pattern 25 to shield the terminal. Shield 24 is configured to be removed by insertion of a tool into slot 26 to exert sufficient force to break engagement tabs 27.

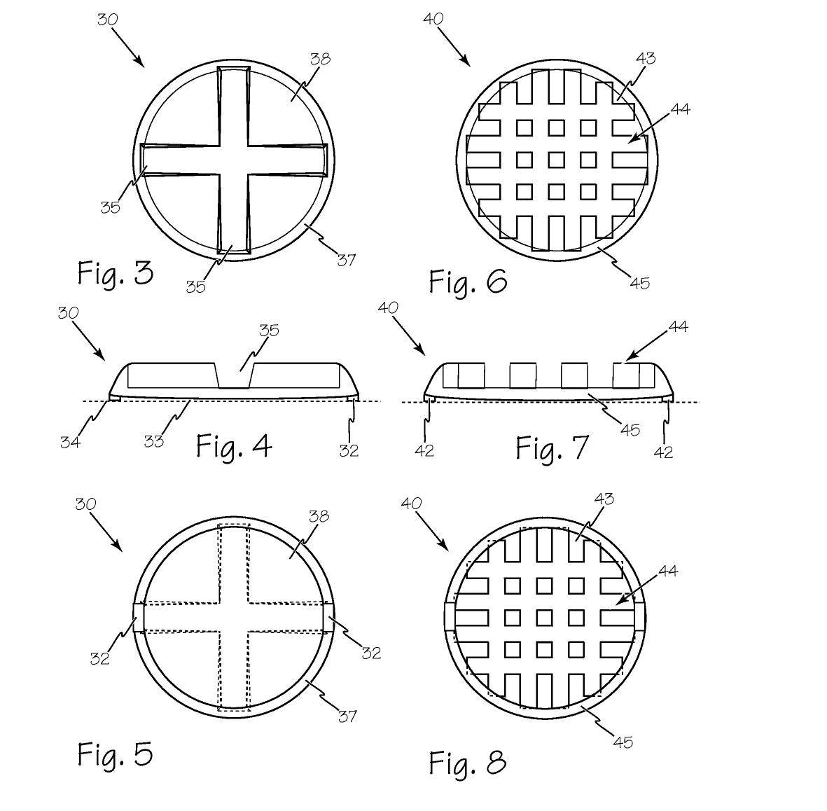

Terminal shield 30 is illustrated in FIGS. 3, 4 and 5. Terminal shields such as shield 30 are secured to a housing using two or more attachment tabs 32. Attachment tabs are sized to create one or more slots such as slot 33 between the terminal shield and housing 34. Terminal shield 30 may be removed by inserting a tool into tool slots 35 or into slots 33 and breaking attachment tabs 32 to expose the terminal. Rim 37 may be thickened or otherwise reinforced on the perimeter of terminal shield body 38 to maintain the integrity of terminal shield 30 as attachment tabs 32 are broken.

Terminal shield 40 is illustrated in FIGS. 6, 7 and 8. Terminal shield 40 is secured to an electrical control housing using two or more attachment tabs 42. Shield body 43 may adopt any suitable shape such as lattice pattern 44 inset or secured to rim 45.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A removable terminal shield comprising:
a shield body with one or more tool engagement features; and
two or more attachment tabs for securing the terminal shield to an electrical control device housing.

2. The removable terminal shield of claim 1 further comprising:
a reinforced rim on the perimeter of the shield body.

3. The removable terminal shield of claim 1 wherein the two or more attachment tabs are sized to create one or more slots between the terminal shield body and the electrical control device housing.

4. The removable terminal shield of claim 1 wherein the tool engagement feature is a slot.

5. The removable terminal shield of claim 1 wherein the tool engagement feature is two perpendicular slots.

6. The removable terminal shield of claim 1 wherein the tool engagement feature is a hexagonal socket.

7. The removable terminal shield of claim 1 wherein the tool engagement feature is a torx socket.
